(19) United States
(12) Patent Application Publication
(10) Pub. No.: US 2014/0004788 A1
(43) Pub. Date: Jan. 2, 2014

(54) Designated Source Radio

(71) Applicant: Jeff Rowe, Cincinnati, OH (US)

(72) Inventor: Jeff Rowe, Cincinnati, OH (US)

(21) Appl. No.: 13/927,406

(22) Filed: Jun. 26, 2013

Related U.S. Application Data
(60) Provisional application No. 61/665,043, filed on Jun. 27, 2012.

(51) Int. Cl. H04H 40/00

(52) U.S. Cl. CPC H04H 40/00
USPC 455/3.06

(57) ABSTRACT

A receiver and methods of providing a single source of programming to a remote location. The receiver includes a receiver circuit configured to provide a single source of programming to a user, such as broadcasts of athletic events for a particular team or university, or the broadcasts of a particular radio station. A dedicated frequency radio at a remote location is matched to a pre-selected designated source broadcast for playing the broadcast at the remote location where the broadcast is not otherwise received, or cannot be easily located.

### CROSS-REFERENCE TO RELATED APPLICATION

This application claims the benefit of and priority to co-pending U.S. Provisional Application Ser. No. 61/665,043, filed on Jun. 27, 2012 and entitled DESIGNATED SOURCE RADIO, the disclosure of which is hereby incorporated by reference in its entirety.

### TECHNICAL FIELD

This invention is related to the fields of information and entertainment and, more particularly, to methods and apparatus for enabling individuals to access radio broadcasts of favorite athletic teams, or of hometown or specific location related programming and the like from remote locations where such broadcasts may not typically be accessible.

### BACKGROUND

There are space and time obstacles to accessing desirable radio broadcasts of specific professional, athletic, collegiate or high school endeavors, or focused localized programs from geographically remote locations. For example, a sports enthusiast may wish to hear the broadcast of an athletic or other event of a college, city or other institution while living in an area geographically remote from where such broadcasts emanate. Displaced persons or others whose life choices have separated them from earlier or sentimental surroundings, such as a hometown, may have a nostalgic urge to reconnect by hearing radio programming from a specific location, but who cannot pick up any transmissions for listening in the locale where they now reside.

To those ends, it is desirable to provide for the receipt of a broadcast at a remote location where the broadcast cannot otherwise be heard. Thus, improved apparatus and methods for providing radio broadcasts to a remote area are needed that allow persons to hear broadcasts that would otherwise be unavailable.

### SUMMARY

One intended application for embodiments of this invention is to serve the rabid sports enthusiast within the United States or other geographies, who ritualistically desires to listen to his “hometown” or alma mater athletic team sporting broadcasts via conventional radio, satellite, Internet services or other means. An additional market is for the “homesick” or nostalgic person, living away from where they grew up, who enjoys listening to familiar voices and familiar news from his/her “hometown”.

An embodiment of the invention comprises a simple, small, lightweight, portable radio or other receiving device (referred to hereinafter as simply a “receiver”). This receiver may resemble a conventional, old fashioned (bedside) radio, and/or may be decorated in accordance with the source material that the receiver is configured to receive. For example, a receiver configured to receive sports broadcasts from a particular school may include school colors, symbols, mascots, or any other suitable school related indicia. A unique feature of the receiver is that the receiver is configured to receive only one channel (e.g., one radio station or other source signal). Embodiments of the invention thus do not include a dial or tuner for searching for other options. Advantageously, by reducing the hassle and confusion that comes from some attempting to operate many consumer electronic devices, this feature may appeal to persons who are overwhelmed by modern technology. To this end, some embodiments may only include a volume control so that the receiver is easy to set up and operate. The receiver in this embodiment is configured to automatically tune to the pre-programmed channel upon being powered up by the user, such as by turning the volume knob in a clockwise direction.

The receiver plays only the pre-programmed single channel, station, or signal (referred to hereinafter as the “source”) when activated by the user. The receiver works by picking up this single source and delivering the content provided by the source to the user's chosen location. To this end, the receiver may be configured at the time of manufacture to determine a source that matches the user's selected programming, station or channel The source may be selected or matched based on the user's chosen remote location, using a mailing zip code or other geographic identification as the means for creating the match, or by associating the source broadcast with a radio signal in the designated address or zip code area.

To enable a user to select a receiver configured to provide the desired source, a provider may publish information by which the sports fan or nostalgic described above can order the single channel radio. For example, the provider may have a web site that includes a catalog or other pre-published list of available sources. The user may view the catalog or list on the provider web site to see available sources. The available sources may be displayed as a pre-published list of sources and received over a global communication network, such as the Internet. Upon ordering, the user may select from the pre-published list of sports teams or other radio sources that is displayed on the web site. The user may then provide a mailing address and zip code, which may be the remote location where the user intends to operate the receiver. At the factory, the receiver may be tuned or otherwise configured so that the selected radio station or other source in the customer's locale which broadcasts the games of the team he has selected is matched to his address and zip code identification. This may include use of known signals available in the remote location.

In an alternative embodiment of the invention, the user may provide a specific call sign or letters that identify the radio station they wish to receive. This call sign may then be matched to the remote location. This allows the user, whether the user is a sports enthusiast or nostalgic, to turn on the receiver anywhere within that remote zip code and receive the broadcast from the particular channel or station he has requested, clearly and without interference. The delivery means may be via a satellite communication link, a cellular network, a microwave or other high frequency signal, via the Internet, or by any other suitable means of communication.

In an embodiment of the invention, a library or database of sources may be established for each area of the country together with the particular programming available for each discernable signal. The user may contact the provider of the service, advise the provider of the broadcast they wish to hear, and their address and zip code. After receiving the order, the provider will tune or otherwise configure the receiver to receive the desired source via a signal available in the customer designated area, and ship the product. Once the radio is received, the customer simply turns the receiver on, which activates the receiver to receive only the pre-tuned source or designated signal frequency so the user is provided with broadcasts of, for example, the selected team's endeavors.

The receiver may receive the desired broadcasts using radio wave signals from broadcasters (when available). The receiver may also use satellite or other transmission techniques, or a signal configured to be received by a signal specific receiver in a remote area not having a suitable over-the-air radio broadcast. The provider may establish a database of available content specific broadcast signals that are coordinated and matched to geographic locations or zip codes. The provider may also acquire access to a large variety of programming and transmission possibilities under appropriate licensing or other handling arrangements with a variety of sources.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of a receiver connected to a source via a communication system.

FIG. 2 is a flow chart depicting a process for configuring the receiver of FIG. 1 for a specific user.

FIG. 3 a flow chart depicting a process for playing a broadcast from the desired source to the user.

### DETAILED DESCRIPTION

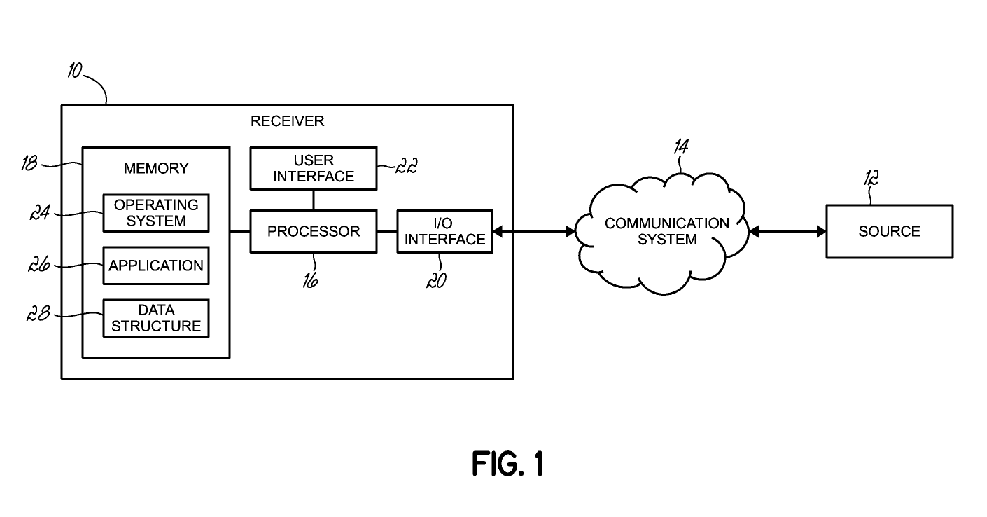

Referring now to FIG. 1, a receiver 10, in accordance with an embodiment of the invention, is shown in communication with a source 12 via a communication network or system 14. The communication system 14 may include a satellite network, one or more terrestrial radio transmitters (e.g., a commercial AM or FM station broadcasting an analog main broadcast signal and/or a digital signal embedded on-frequency within a station's standard analog signal), a cellular network, the Internet, a network access point (e.g., an access point using the IEEE 802.11 wireless interface protocol), a transmitter transmitting in an unlicensed band, or any other suitable network, communication system or transmitter. The source 12 may be any suitable source of programming, such as a commercial radio station, a university radio station, an Internet radio station, a web stream from a radio station or university web site, or a broadcast network feed, to name but a few.

The receiver 10 may include a receiver circuit configured to receive and decode a signal received from the source 12 via the communication network 14. To this end, the receiver circuit may include a processor 16, a memory 18, an input/output (I/O) interface 20, and a user interface 22. The processor 16 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 18. Memory 18 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. In an alternative embodiment, the processor 16 may comprise a radio receiver circuit configured to receive signals (analog or digital) from the source 12 via an over-the-air broadcast.

Processor 16 may operate under the control of an operating system 24 that resides in memory 18. The operating system 24 may manage computer resources so that computer program code embodied as one or more computer software applications, such as application 26 residing in memory 18, may have instructions executed by the processor 16. In an alternative embodiment, the processor 16 may execute the applications 26 directly, in which case the operating system 24 may be omitted. One or more data structures 42 may also reside in memory 18, and may be used by the processor 16, operating system 24, and/or application 26 to store or manipulate data.

The I/O interface 20 may provide a machine interface that operatively couples the processor 16 to other devices and systems, such as the communication system 14. To this end, the I/O interface 20 may include a network interface that connects to the communication system 14 via suitable network communication protocol, such as the Transmission Control Protocol/Internet Protocol (TCP/IP) over Ethernet, or the IEEE 802.11 protocol (Wi-Fi) over a wireless link The I/O interface 20 may also include a suitable radio transceiver circuit configured to support a wireless link to the communication system 14 by transmitting and/or receiving radio and/or other electromagnetic signals. These signals may be analog (e.g., Analog Modulated (AM) or Frequency Modulated (FM) signals), or digital (e.g., Global System for Mobile Communications (GSM), Enhanced Data rates for GSM Evolution (EDGE), Code Division Multiple Access (CDMA), Wi-Fi, etc.). The I/O interface 20 may thereby communicatively couple the receiver 10 to the communication system 14 wirelessly. The I/O interface 20 provides a communication link between the processor 16 and the communication system 14 so that signals and/or data may be exchanged between the processor 16 and source 12. The receiver 10 may thereby work cooperatively with the communication system 14 and/or source 12 by communicating via the I/O interface 20 to provide the various features and functions of embodiments of the invention.

The user interface 22 may be operatively coupled to the processor 16 of receiver 10 in a known manner to allow a user to interact directly with the receiver 10. The user interface 22 may include video and/or alphanumeric displays, a speaker, and any other suitable audio and visual indicators capable of providing information to the user. In an embodiment of the invention, the user interface 22 has a single input device. This input device may be a volume knob, or other suitable control input device. The receiver 10 may thereby be configured so that the only adjustment that can be made by the user is to turn the receiver 10 on and off, and adjust the volume of audio being output by the receiver 10.

In an embodiment of the invention, the application 26 may include program code that is executed by one or more external resources (not shown), or otherwise rely on functions and/or signals provided by other system or network components external to the receiver 10. Indeed, given the nearly endless hardware and software configurations possible, persons having ordinary skill in the art will understand that embodiments of the invention may include applications and/or circuits that are located externally to the receiver 10, distributed among multiple computers or other external resources, or provided by computing resources (hardware and software) that are provided as a service over the communication system 14, such as a cloud computing service.

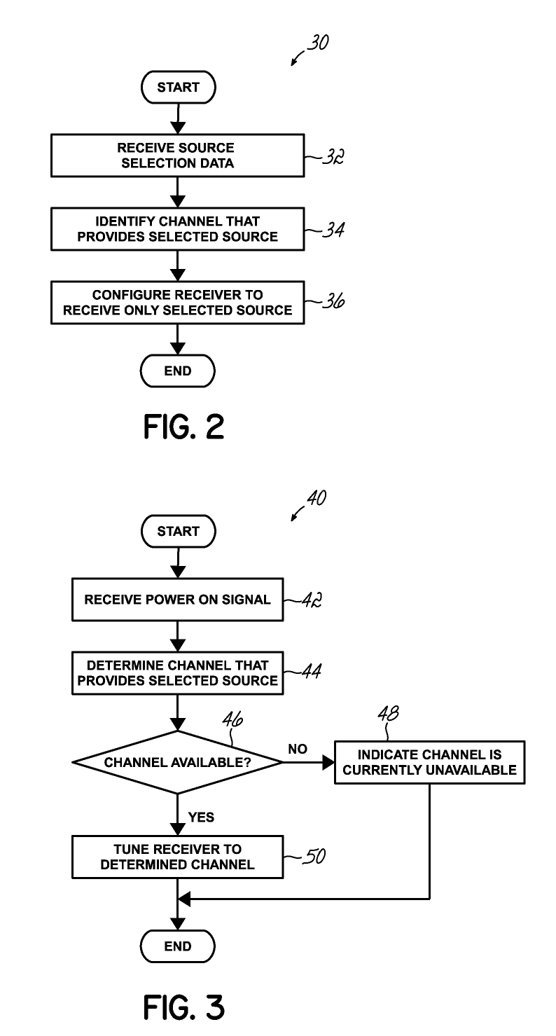

Referring now to FIG. 2, a process 30 of providing and/or configuring the receiver 10 for the user is depicted. The process 30 may be part of, for example, a method of ordering the receiver over the Internet. At block 32, the process 30 receives source selection data from the user. This data may be indicative of a particular type of programming that the user wishes to receive on the receiver 10. Examples of sources 12 may include a terrestrial radio station, a university athletic department radio network (e.g., “Crimson Tide radio network”), a university streaming audio site, a local radio station having a broadcast limited to a particular geographic region, or any other single source of audio programming The user may select the source 12 by browsing a menu of available sources 12, or may enter a desired type of programming (e.g., University of Alabama Football, a radio call sign, Reds Baseball, etc.) into a search engine that identifies available sources 12 matching the search terms. The source selection data may also include data relating to a geographic location of the remote location in which the user wishes to receive the desired programming This data may include, for example, an address or zip code of the remote location. The geographic location of the remote location may, in turn, be used to determine what, if any, signals are available in the remote area that could be used to deliver the selected source programming.

In response to receiving the source selection data, the process 30 may proceed to block 34. In block 34, the process 30 identifies a channel that provides the selected source. This channel may be, for example, an address on the Internet or some other suitable network that provides streaming audio containing the desired programming, a local radio station in the remote location, a satellite feed, or any other suitable signal or channel Once the channel has been identified, the process 30 may proceed to block 36.

In block 36, the receiver 10 is configured to receive the identified channel. This configuration may include storing a link to a streaming web site or a radio frequency as a data structure 28 in a non-volatile portion of the memory 18. In an alternative embodiment of the invention, the receiver 10 may be programmed with data identifying a link to information that configures the radio when the receiver 10 is activated. Receiver configuration may include providing an exterior housing for the receiver 10 that reflects the user's choice of programming To this end, the exterior of the receiver 10 may include colors and insignia indicative of the source, such as university colors or symbols, and/or may be configured to play a school fight song or other theme associated with the desired source programming In any case, once the receiver 10 is configured to receive the desired programming, the receiver may be supplied to the user using any suitable means.

Referring now to FIG. 3, a process 40 that may be executed by the application 26 is depicted. In block 42, the receiver 10 receives a power on signal. This signal may be received, for example, in response to the user rotating a rotary volume knob that is part of the user interface 22. In response to receiving the power on signal, the receiver 12 may proceed to block 42. In block 42, the receiver 10 may determine the channel that provides the user selected source programming. This determination may be made by retrieving data stored by the manufacture in the memory 18, as described above. The data stored in memory 18 may be indicative of the channel which carries the desired programming (e.g., a web link, a Uniform Resource Locator (URL), and/or a local radio frequency (e.g., 700 KHz) available in the remote location).

In an alternative embodiment of the invention, the data may identify a link to the provider's web site that, in turn, provides data identifying the source 12. That is, the receiver 10 may be configured to establish a link to the provider's web site based on the data in memory 18. The receiver 10 may then request data identifying a link to the source 12 from the web site. This alternative embodiment may thereby enable the receiver 10 to connect to the selected source 12 through a link provided on demand from the provider web site. This may enable the receiver 10 to connect to the source 12 even if a previously used link to the source 12 becomes unavailable (e.g., particular link ceases to exist or is moved) by placing the receiver 10 in communication with the source 12 via another link.

In block 44, the process 40 may determine if a channel connecting the receiver 10 to the source 12 is available. If the channel is available, (“YES” branch of decision block 44), the process 40 may proceed to block 48 and tune the receiver to the desired channel In response to being tuned to the desired channel, the receiver 10 may begin to output audio received from the source 12. If a channel is not available that connects the receiver 10 to the source 12 (“NO” branch of decision block 44), the process 40 may proceed to block 46 and cause the receiver 10 to provide an indication to the user that the desired source 12 is currently unavailable. This may occur, for example, if a radio station or network access point used by the receiver 10 is off the air or out of range. In this case, the user may also be instructed to try again later.

The program code embodying any of the embodiments of the invention described herein is capable of being individually or collectively distributed as a program product in a variety of different forms. In particular, the program code may be distributed using a computer readable media, which may include computer readable storage media and communication media. Computer readable storage media, which are inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Communication media may embody computer readable instructions, data structures, or other program modules. By way of example, and not limitation, communication media may include wired media, such as a wired network or direct-wired connection, and wireless media, such as acoustic, RF, infrared and other wireless media. Combinations of any of the above may also be included within the scope of computer readable media.

The methods described herein can be implemented by computer program instructions supplied to the processor of any type of computer to produce a machine with a processor that executes the instructions to implement the functions/acts specified herein. These computer program instructions may also be stored in a computer readable medium that can direct a computer to function in a particular manner. To that end, the computer program instructions may be loaded onto a computer to cause the performance of a series of operational steps and thereby produce a computer implemented process, such that the executed instructions provide processes for implementing the functions/acts specified herein.

In addition, program code described herein may be identified based upon the application or software component within which the program code is implemented in a specific embodiment of the invention. However, it should be appreciated that any particular program nomenclature that follows is used merely for convenience, and thus the invention should not be limited to use solely in any specific application identified and/or implied by such nomenclature. It should be further appreciated that the various features, applications, and devices disclosed herein may also be used alone or in any combination. Moreover, given the typically endless number of manners in which computer programs may be organized into routines, procedures, methods, modules, objects, and the like, as well as the various manners in which program functionality may be allocated among various software layers that are resident within a typical computing system (e.g., operating systems, libraries, APIs, applications, applets, etc.), and/or across one or more hardware platforms, it should be appreciated that the invention is not limited to the specific organization and allocation of program functionality described herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of” or variants thereof are used in either the detailed description or the claims, such terms are intended to be inclusive in a manner similar to the term “comprising.”

While embodiments of the invention have been illustrated by a description of various examples, and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept.

What is claimed is:

1. A receiver comprising:
a user interface lacking an input device capable of tuning the receiver; and
a receiver circuit coupled to the user interface and configured to receive a signal from a single source of programming, decode audio carried by the signal, and play the audio to the user via the user interface, the receiver thereby being configured to only receive programming from the single source.

2. The receiver of claim 1 wherein the receiver circuit is configured by a manufacturer of the receiver to receive the signal from the single source prior to providing the receiver to the user.

3. The receiver of claim 1 wherein the single source of programming provides programming from the group consisting of broadcasts of an athletic team, and broadcasts from a radio station located in a particular geographic location.

4. The receiver of claim 1 wherein the receiver circuit comprises a processor and memory, the memory including program code that, when executed by the processor, causes the processor to receive the signal from the single source.

5. The receiver of claim 4 wherein the program code is further configured to cause the processor to:
establish a link to a web site;
query the web site for data identifying a link to the single source of programming; and
receive the signal from the single source over the identified link.

6. The receiver of claim 1 wherein the receiver circuit is further configured to determine a channel for receiving the signal from the single source of programming based at least in part on a remote location of the receiver.

7. The receiver of claim 1 further comprising:
a housing that includes indicia reflective of a subject matter of the single source of Programming.

8. The receiver of claim 7 wherein the indicia includes at least one of a school color or a school symbol.

9. A method of providing a radio receiver to a user, the method comprising:
receiving, at a computer, data indicating a single source of programming selected by a user;
identifying a channel that provides the selected single source of programming; and
configuring a receiver to receive only the single source of programming.

10. The method of claim 9 wherein the data indicating the single source of programming includes data identifying a desired subject matter of the single source of programming.

11. The method of claim 10 further comprising:
receiving data indicative of a geographic location where the programming is desired to be heard; and
matching the programming with a radio signal receivable in the geographic location, wherein
configuring the receiver to receive only the single source of programming includes tuning the receiver to receive the radio signal.

12. A method of providing audio programming to a user from a single source of audio programming, the method comprising:
in response to receiving a power on signal, activating a receiver circuit;
in response to being activated, determining, with the receiver circuit, a channel that provides the single source of programming; and
tuning the receiver to the channel.

13. The method of claim 12 further comprising:
in response to the channel not being available, providing an indication to the user that the channel is unavailable.

14. The method of claim 12 wherein determining the channel that provides the single source of programming comprises:
establishing a link to a provider web site; and
receiving data from the web site that identifies the channel.

15. The method of claim 12 wherein determining the channel that provides the single source of programming comprises establishing a link to a provider web site, the web site providing the single source of programming via the link.
